(19) United States
(12) Patent Application Publication
(10) Pub. No.: US 2026/0151667 A1
(43) Pub. Date: Jun. 4, 2026

(54) SYSTEM AND METHOD FOR A SIMULATED WALKABLE SCENE-BASED ATTRACTION

(71) Applicant: Universal City Studios LLC, Universal City, CA (US)

(72) Inventors: Eric To Chan, Kissimmee, FL (US); Cole Paresh Hirapara, Orlando, FL (US)

(21) Appl. No.: 19/405,834

(22) Filed: Dec. 2, 2025

Related U.S. Application Data
(60) Provisional application No. 63/727,503, filed on Dec. 3, 2024.

(51) Int. Cl. A63B 22/02; A63B 24/00; A63G 31/02; G06F 3/01

(52) U.S. Cl. CPC A63B 22/02; A63B 24/0059; A63G 31/02; G06F 3/011; A63B 2022/0271; G06F 2203/012

(57) ABSTRACT

An attraction system may include an omnidirectional treadmill configured to output an indication of movement, a vehicle configured to support a rider and move along a path in a riding configuration and facilitate rider engagement with the omnidirectional treadmill in a walking configuration, and a controller communicatively coupled to the omnidirectional treadmill and the vehicle. The controller may be configured to instruct the vehicle to transition from the riding configuration to the walking configuration in response to a triggering event.

### CROSS-REFERENCE TO RELATED APPLICATION

This application claims priority from and the benefit of U.S. Provisional Patent Application No. 63/727,503, entitled “SYSTEM AND METHOD FOR A SIMULATED WALKABLE SCENE-BASED ATTRACTION”, filed December 03, 2024, which is hereby incorporated by reference in its entirety for all purposes.

### BACKGROUND

The subject matter disclosed herein relates to amusement park attractions, and more specifically, to providing augmented reality experiences, virtual reality experiences, or both in amusement park attractions.

Amusement parks include a variety of features to entertain guests and patrons. For example, an amusement park may include an attraction system, which may include a ride vehicle. A guest may be positioned within the ride vehicle, and the ride vehicle may travel along a path. Movement of the ride, such as along the path, may entertain the guest. For example, movement of the ride vehicle carrying the guest may impart various sensations onto the guest and/or transport the guest to various locations. The attraction system may also provide show effects to entertain the guest positioned within the ride vehicle.

This section is intended to introduce the reader to various aspects of art that may be related to various aspects of the present disclosure. This discussion is believed to be helpful in providing the reader with background information to facilitate a better understanding of the various aspects of the present disclosure. Accordingly, it should be noted that these statements are to be read in this light and not as admissions of prior art.

### SUMMARY

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In an embodiment, an attraction system may include an omnidirectional treadmill configured to output an indication of movement, a vehicle configured to support a rider and move along a path in a riding configuration and facilitate rider engagement with the omnidirectional treadmill in a walking configuration, and a controller communicatively coupled to the omnidirectional treadmill and the vehicle. The controller may be configured to instruct the vehicle to transition from the riding configuration to the walking configuration in response to a triggering event.

In an embodiment, an attraction system may include an omnidirectional treadmill configured to output an indication of movement and a vehicle to transition between a riding configuration and a walking configuration. The vehicle is configured to traverse a path in the riding configuration and to remain stationary relative to the path to facilitate rider engagement with the omnidirectional treadmill in the walking configuration.

In an embodiment, an attraction system may include a show effect system configured to display image data, an omnidirectional treadmill configured to output an indication of movement of a treadmill component, a vehicle configured to support a rider and move along a path in a riding configuration and facilitate rider engagement with the omnidirectional treadmill in a walking configuration, and a controller communicatively coupled to the omnidirectional treadmill and the vehicle. The controller may be configured to instruct the vehicle to transition from the riding configuration to the walking configuration in response to a triggering event and generate image data for the show effect system based on the indication of movement from the omnidirectional treadmill.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of an attraction system with a walkable ride system, in accordance with an embodiment of the present disclosure;

FIG. 2 is a schematic diagram of the walkable ride system of FIG. 1, in accordance with an embodiment of the present disclosure;

FIG. 3 is a flowchart of an example method for operating the walkable ride system of FIG. 1, in accordance with an embodiment of the present disclosure;

FIG. 4 is a schematic diagram of an embodiment of the walkable ride system of FIG. 1 transitioning from a riding configuration to a walking configuration, in accordance with an embodiment of the present disclosure;

FIG. 5 is a schematic diagram of an embodiment of the walkable ride system of FIG. 1 transitioning from the riding configuration to the walking configuration, in accordance with an embodiment of the present disclosure;

FIG. 6 is a schematic diagram of an embodiment of the walkable ride system of FIG. 1 transitioning from the riding configuration to the walking configuration, in accordance with an embodiment of the present disclosure;

FIG. 7 is a schematic diagram of an embodiment of the walkable ride system of FIG. 1 transitioning from the riding configuration to the walking configuration, in accordance with an embodiment of the present disclosure; and

FIG. 8 is a flowchart of an example method of the walkable ride system of FIG. 1 displaying image data in the walking configuration, in accordance with an embodiment of the present disclosure.

### DETAILED DESCRIPTION

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Additionally, it should be noted that references to “one embodiment” or “an embodiment” of the present disclosure are not intended to be interpreted as excluding the existence of additional embodiments that also incorporate the recited features.

While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The present disclosure is directed to providing show effects for an amusement or theme park. The amusement park may include a variety of features, such as rides (e.g., a roller coaster), theatrical shows, set designs, performers, and/or decoration elements, to entertain guests. An attraction system may employ different features to provide guests with a unique experience. For example, the attraction system may include a ride with a ride vehicle that moves along a track or a path. Show effects may be used to supplement or complement the features, such as to provide the guests with a more immersive and/or interactive experience.

Present embodiments are directed to a walkable ride system that includes a vehicle and an omnidirectional treadmill for engagement with a guest during a ride. For example, the presently disclosed walkable ride system may include a vehicle capable of traveling along a track or path and stopping along the track or path to allow the guest to engage with an omnidirectional treadmill for a period of time. An omnidirectional treadmill may include a mechanical device (e.g., a scrolling surface disposed on rollers) that facilitates human engagement and locomotion (e.g., ambulation via engagement with feet) in at least four directions (e.g., front, back, left, right). In some embodiments, the omnidirectional treadmill may facilitate up to 360 degrees of directional movement. In addition to the vehicle and the omnidirectional treadmill, the walkable ride system may include show effects, such as show effects directed towards augmented reality (AR), virtual reality (VR), or both, to provide unique special effects to the guest in coordination with respective ride experiences (e.g., riding or walking) provided by the walkable ride system. As such, the walkable ride system may provide a unique and/or immersive experience for the guest. It should be noted that, while an omnidirectional treadmill or multiple omnidirectional treadmills are primarily discussed in the present disclosure, embodiments may be implemented in which one or more omnidirectional treadmills are replaced with any type of treadmill (e.g., a mono-directional treadmill that facilitates locomotion in a single direction, a bidirectional treadmill that facilitates locomotion in two directions, and so forth). Indeed, one of ordinary skill in the art will recognize that the illustrated omnidirectional treadmills are representative of any type of treadmill.

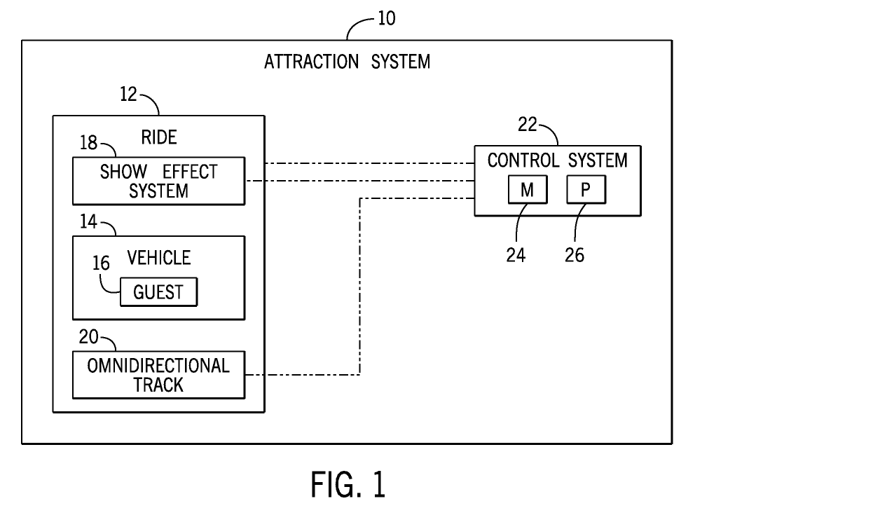

With the preceding in mind, FIG. 1 is a schematic diagram of an embodiment of an attraction system 10 of an amusement or theme park. For example, the attraction system 10 may include a ride 12, such as a roller coaster, a motion simulator, a dark ride, a water ride, a walk-through attraction (e.g., a maze), and the like. The ride 12 may include a vehicle 14 (e.g., ride vehicle) that may move (e.g., translate, rotate, pivot) about a motion base, a robot arm and/or along a track of the ride 12 in an embodiment.

One or more guests 16 may be positioned within the vehicle 14. As an example, the one or more guests 16 may enter the vehicle 14 from a guest area (e.g., a queue, loading platform, unloading platform) and/or exit the vehicle 14 to the guest area to move between the guest area and the ride 12. The ride 12 may entertain one or more guests 16 via movement of the vehicle 14, such as by providing certain movement sensations for one or more guests 16 (e.g., rider). Additionally or alternatively, a show effect system 18 may provide entertainment to the one or more guests 16 positioned in the vehicle 14, such as by providing realistic and/or simulated visual effects and/or audio effects. In this manner, the show effect system 18 may be controlled to entertain guests 16 before, during, and/or after the ride 12.

In an embodiment, the show effect system 18 may provide virtual reality (VR) effects and/or augmented reality (AR) effects to the guests 16. The show effect system 18 may include a display system, AR/VR glasses, or both. For example, the display system may include any suitable display (e.g., liquid crystal display (LCD), light emitting diode (LED) display, an organic light emitting diode (OLED) display, a micro-LED display), and/or a projector with a screen that receives image data and projects (e.g., displays) the image data as an image (e.g., virtual image, image content). In an example, the AR/VR system may include a wearable visualization device (e.g., head mounted display, goggles, glasses) which may be worn by the one or more guests 16 and may be configured to enable the one or more guests 16 to view AR/VR scenes. The AR/VR system may include transparent (e.g., see-through) LED displays or transparent (e.g., see-through) OLED displays that display image data. In certain instances, the AR/VR system may be utilized to enhance a guest experience by virtually overlaying features (e.g., AR features) in a real-world environment of the amusement park, by providing adjustable virtual environments to provide different experiences within the amusement park. In other instances, the AR/VR system may completely control the view of the one or more guests 16 (e.g., using opaque viewing surfaces) to display virtual features. It may be appreciated that the AR/VR system may provide an AR experience, a VR experience, a mixed reality experience, a computer-mediated reality experience, or any combination thereof. Moreover, it should be understood that the AR/VR system may be used alone or in combination with other features to create an immersive and entertaining environment for the one or more guests 16. For example, the one or more guests 16 may wear the AR/VR system during a portion of the ride 12 to view images and take off the AR/VR system during another portion of the ride to view images displayed by the display system. The show effect system 18 may also include speakers that output audio effects for the one or more guests 16, props that output visual and/or audio effects for the one or more guests 16, and so on. As such, the show effect system 18 may provide show effects to the one or more guests 16.

The ride 12 may also include one or more omnidirectional treadmills 20 (e.g., track, platform) that are operable to engage with the one or more guests 16 (e.g., the feet of the one or more guests 16 may engage with one or more surfaces of the one or more omnidirectional treadmills 20) to provide a unique and/or immersive walking experience for the one or more guests 16 during operation (e.g., a cycle) of the ride 12. For example, the one or more omnidirectional treadmills 20 may engage with the one or more guests 16 and allow the one or more guests 16 to walk in any direction while remaining in a stationary position. The one or more omnidirectional treadmills 20 may include moving belts, wheels, and/or spheres that may slide and/or roll in any direction. The one or more omnidirectional treadmills 20 may generate an indication of a speed of movement, a direction of movement, an acceleration rate, or any combination thereof based on the movement of the one or more guests 16 during the rider engagement. As further described herein, the one or more omnidirectional treadmills 20 may be positioned within the vehicle 14 and/or fixed in a location within the ride 12. It should be noted that the terms “walk” and “walking,” as used in the present disclosure, reference an ambulatory motion (e.g., coordinated movement of legs in a manner that would typically progress a person in a direction, such as running, skipping, jumping, crawling, and the like). While such movement would typically cause a transition of locations, present embodiments simulate such transition by moving the one or more surfaces or interface (e.g., ground surface) of the one or more omnidirectional treadmills 20 contacted by the guest performing the ambulatory motion.

The attraction system 10 may also include a control system 22 (e.g., an automated or programmable controller) configured to operate the ride 12, the show effect system 18, and/or the one or more omnidirectional treadmills 20. The control system 22 may include a memory 24 and processing circuitry 26. The memory 24 may include volatile memory, such as random access memory (RAM), and/or non-volatile memory, such as read-only memory (ROM), optical drives, hard disc drives, solid-state drives, or any other non-transitory computer-readable medium that includes instructions to operate the attraction system 10. The memory 24 may store image data, one or more locations within the ride 12 that correspond to a transition between a riding configuration and a walking configuration, and so on. The processing circuitry 26 may be configured to execute such instructions. For example, the processing circuitry 26 may include one or more application specific integrated circuits (ASICs), one or more field programmable gate arrays (FPGAs), one or more general purpose processors, or any combination thereof.

The control system 22 may communicatively couple to the ride 12, the show effect system 18, and the one or more omnidirectional treadmills 20. For example, the control system 22 may control movement of the vehicle 14 within the attraction system 10, control operation (e.g., transitioning into an engagement configuration) of the one or more omnidirectional treadmills 20, and/or various outputs provided by the show effect system 18. Additionally or alternatively, the control system 22 may instruct the vehicle 14 to transition from a riding configuration to a walking configuration at a location within the ride 12. For example, the control system 22 may monitor a location of the vehicle 14 within the ride 12, and if the location of the vehicle 14 matches a stored location, the control system 22 may instruct the vehicle to transition from the riding configuration to the walking configuration. In the walking configuration, the one or more guests 16 may engage with the one or more omnidirectional treadmills 20. After a period of time, upon receipt of designated feedback, or some other prompt (e.g., an audio signal, receipt of sensor data), the control system 22 may instruct the vehicle 14 to transition from the walking configuration to the riding configuration and instruct the vehicle to traverse through the ride 12.

Transitioning between the riding configuration and the walking configuration may include moving the one or more omnidirectional treadmills 20 into and out of a position for engagement with the feet of a guest 16 of the one or more guests 16 secured in the vehicle 14. Additionally or alternatively, transitioning between the riding configuration and the walking configuration may include rider engagement between the one or more guests 16 and the one or more omnidirectional treadmills 20, such as by adjusting a position and/or orientation of a seat within the vehicle 14. For example, the control system 22 may instruct the vehicle 14 to adjust a position and/or a location of the one or more omnidirectional treadmills 20 to facilitate engagement with the one or more guests 16. In an embodiment, the one or more omnidirectional treadmills 20 may be positioned within the vehicle 14 and transition from a folded configuration (in coordination with the riding configuration of the vehicle 14) to a walking configuration (in coordination with the walking configuration of the vehicle 14), wherein the one or more omnidirectional treadmills 20 is unfolded and reachable by feet of the one or more guests 16 secured within the vehicle 14. As such, the one or more guests 16 may interact (e.g., engage) with the one or more omnidirectional treadmills 20 and “walk” (e.g., perform a walking motion) during the ride 12. In an embodiment, the one or more omnidirectional treadmills 20 may be lifted or rotated into reach of the one or more guests 16 as part of the walking configuration and lowered or rotated out of reach of the one or more guests 16 in the riding configuration. Other transitional operations for transitioning between the riding and walking configurations are also contemplated, as will be understood by one of ordinary skill in the art.

During operation of the ride 12, the control system 22 may generate image data and instruct the show effect system 18 to output the image data as images in coordination with certain ride conditions. For example, different media types and systems may be utilized to present the images depending on whether the ride 12 is in the riding configuration or the walking configuration. The control system 22 may generate and/or adjust the image data and/or what is outputting the image data based on a location of the vehicle 14 within the ride 12, a configuration of the vehicle 14, and/or an indication from the one or more omnidirectional treadmills 20. For example, the image data may facilitate storytelling during the ride 12 and the control system 22 may update the image data based on a location of the vehicle 14 within the ride 12. In an example, in the riding configuration, the control system 22 may generate image data and instruct a first media device (e.g., AR/VR glasses) of the show effect system 18 to output the image data, and in the walking configuration, the control system 22 may instruct a second media device (e.g., a panel display system) of the show effect system 18 to output the image data. In certain instances, the control system 22 may adjust (e.g., update) the image data based on an indication of movement received from the one or more omnidirectional treadmills 20. For example, the one or more omnidirectional treadmills 20 may output an indication of the one or more guests 16 walking in a particular direction or at a particular speed. If the indication indicates that the one or more guests 16 are walking in a particular direction, the control system 22 may update the image data to depict positional progress in the particular direction (e.g., a building depicted in the distance may be displayed as progressively larger to simulate physically approaching the building). As such, the control system 22 may create an immersive and/or interactive environment for the one or more guests 16.

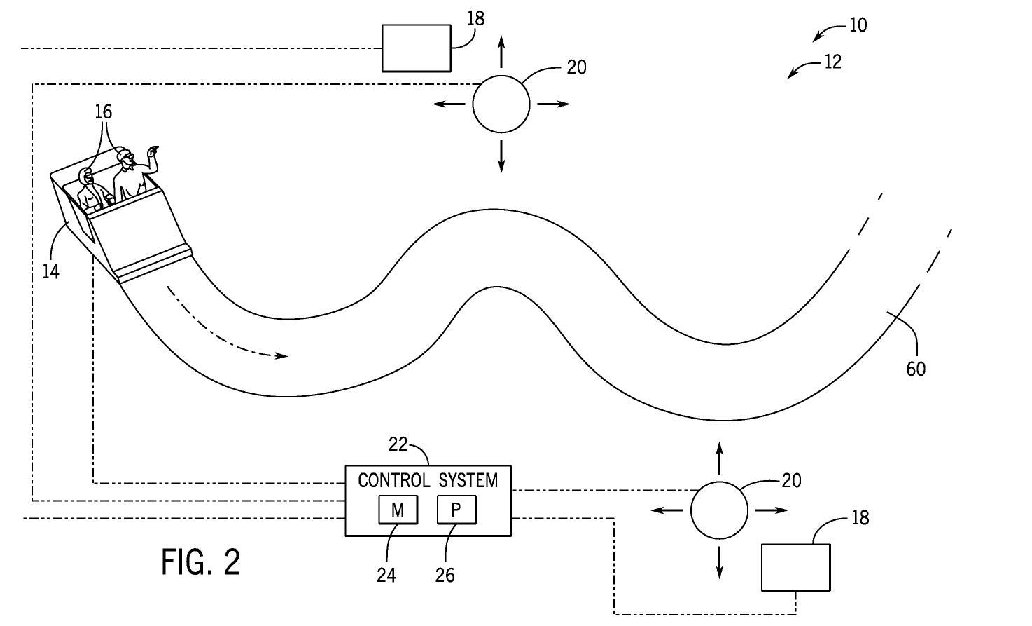

With the foregoing in mind, FIG. 2 is a schematic view of an embodiment of the attraction system 10 that includes the ride 12 with the vehicle 14 and multiple of the omnidirectional treadmills 20. As illustrated, the vehicle 14 may traverse a track or path 60 of the ride 12. For example, the control system 22 may instruct the vehicle 14 to traverse the path 60 in a riding configuration. At certain locations along the path 60 or when some other form of feedback is received (e.g., a proximity sensor is triggered, a type of operator or guest input is received, a certain time has elapsed) the control system 22 may instruct the vehicle 14 to transition from the riding configuration to the walking configuration. Based on another triggering event (e.g., after a period of time, a proximity sensor is activated, a media presentation is complete, guest input is received), the control system 22 may instruct the vehicle 14 to transition back to the riding configuration and continue traversing the path 60. As illustrated, the ride 12 may include two locations along the path 60 in which the vehicle 14 may transition from the riding configuration to the walking configuration. In other words, the ride 12 may include two locations in which the one or more guests 16 may interact with the one or more omnidirectional treadmills 20. In the illustrated embodiment, there are two omnidirectional treadmills 20 positioned proximate to the path 60. However, in an embodiment, more than two omnidirectional treadmills 20 may be employed and/or a single one of the one or more omnidirectional treadmills 20 may be employed. In an embodiment, a single one of the one or more omnidirectional treadmills 20 may be transitioned to different locations for use at the different locations within the ride 12. In certain instances, multiple omnidirectional treadmills 20, such as one of the one or more omnidirectional treadmills 20 per guest 16 of the one or more guests 16 within the ride vehicle 14, may be transitioned between the different locations to facilitate rider engagement. The control system 22 may receive an indication of movement for each of the one or more guests 16 and update the image data for each of the one or more guests 16 based on the indication of movement. In an embodiment, the ride 12 may include a show effect system 18 positioned proximate to the one or more omnidirectional treadmills 20 to display image data to the one or more guests 16 with the vehicle 14 in the walking configuration.

In the walking configuration, the vehicle 14 may be stationary to facilitate rider engagement with the one or more omnidirectional treadmills 20. The one or more omnidirectional treadmills 20 may be positioned within the vehicle 14 and/or positioned proximate to the path 60. To interact with the one or more omnidirectional treadmills 20, the one or more guests 16 may stand on the one or more omnidirectional treadmills 20 (e.g., engage their feet with the one or more omnidirectional treadmills 20) and move in any direction. In other words, the one or more guests 16 may “walk” around (e.g., engage in a walking motion) on the one or more omnidirectional treadmills 20 in the walking configuration. As the one or more guests 16 interacts with the one or more omnidirectional treadmills 20, the control system 22 may receive an indication of movement from the one or more omnidirectional treadmills 20 and adjust image data provided to the one or more guests 16 based on the movement. In an embodiment, for example, the show effect system 18 may include a display system proximate to the vehicle 14 and configured to output image data to the one or more guests 16. For example, the image data may be indicative of a forest. As the one or more guests 16 move on the one or more omnidirectional treadmills 20, the control system 22 may update the image data to be indicative of different areas of the forest. The control system 22 may update the image data at a rate similar to a speed at which the one or more guests 16 may be moving on the one or more omnidirectional treadmills 20. For example, the control system 22 may increase a rate at which the image data may be updated as the speed of the one or more guests 16 on the one or more omnidirectional treadmills 20 increases. Further, the control system 22 may adjust a point-of-view with respect to the image data based on a direction in which the one or more guests 16 may be moving on the one or more omnidirectional treadmills 20. As such, the control system 22 may provide an immersive and/or interactive experience for the guest. Indeed, present embodiments may coordinate the image data (e.g., data from a 3D model) with the data from the one or more omnidirectional treadmills 20 to simulate actual movement through a three-dimensional space.

In certain embodiments, the ride 12 may not include a path 60 and the vehicle 14 may be actuated from a stationary location (e.g., a motion base in a fixed position). For example, the vehicle 14 may include a cabin that is coupled to a vehicle actuator 62 (e.g., a robot arm, a motion base) that adjusts a position and/or orientation of the one or more guests 16 (via movement of the vehicle 14, which may include a harness, cabin, secured seating, or the like) relative to the one or more omnidirectional treadmills 20. To initiate the riding configuration, the vehicle actuator may adjust the position and/or the orientation of the one or more guests 16 in a vertical direction to disengage the one or more guests 16 from the one or more omnidirectional treadmills 20. The vehicle actuator may move the one or more guests 16 in any suitable direction to create movement and/or simulate an experience (e.g., floating in space) for the one or more guests 16. In the walking configuration, the vehicle actuator may lower the one or more guests 16 in the vertical direction to facilitate engagement between the one or more guests 16 and the one or more omnidirectional treadmills 20. As the one or more guests 16 interact with the one or more omnidirectional treadmills 20, the control system 22 may update image data provided to the one or more guests 16 via the show effect system 18. For example, the one or more guests 16 may wear AR/VR glasses during the ride 12 and view images displayed by the AR/VR glasses. Additionally or alternatively, the control system 22 may update the image data based on the configuration of the vehicle actuator. As such, the control system 22 may provide an immersive and/or interactive experience for the one or more guests 16.

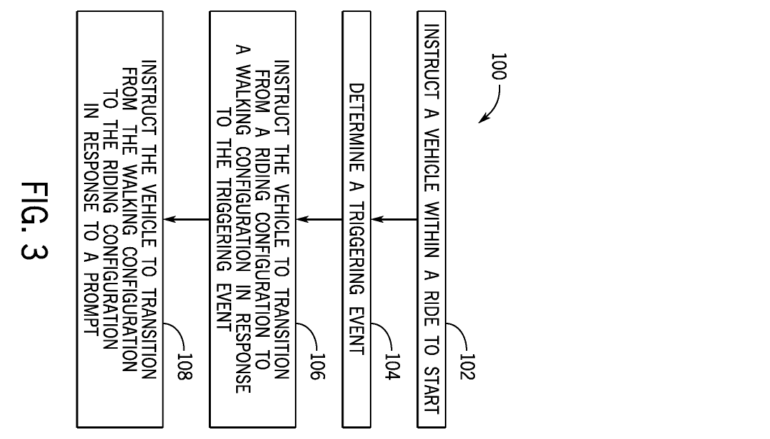

FIG. 3 is a flowchart of an example method 100 for operating the walkable ride system of the attraction system. Any suitable device (e.g., the processing circuitry 26 of the control system 22 illustrated in FIGS. 1 and 2) may perform the method 100. In an embodiment, the method 100 may be implemented by executing instructions stored in a tangible, non-transitory, computer-readable medium (e.g., the memory 24 of the control system 22). For example, the method 100 may be performed at least in part by one or more software components, one or more software applications, and the like. While the method 100 is described using steps in a specific sequence, additional steps may be performed, the described steps may be performed in different sequences than the sequence illustrated, and/or certain described steps may be skipped or not performed altogether.

At block 102, the control system may instruct a vehicle within a ride to start after a series of conditions are met (e.g., loading conditions). For example, the guest may enter the vehicle from the guest area and sit or stand within the vehicle to experience the ride. Additionally or alternatively, the guest may be secured within the vehicle (e.g., via a harness that couples to the vehicle for security during the ride). After the guest enters and/or couples to the vehicle, the control system may instruct the vehicle to start. In an embodiment, the control system may instruct the vehicle to travel along a path. In other embodiments, the control system may instruct the vehicle to adjust a position and/or orientation. This may include the control system instructing the vehicle to be in a riding configuration.

At block 104, the control system may determine a triggering event has occurred (e.g., the vehicle has reached a location within the ride, a designated time has elapsed, user input has been received). For example, the control system may determine that a position of the vehicle with respect to the path corresponds to a portion of the ride that includes a walking simulation. In another example, the control system may determine a position and/or orientation of the vehicle corresponds to a portion of the ride that includes a walking simulation.

At block 106, the control system may instruct the vehicle to transition from a riding configuration to a walking configuration in response to determining the triggering event has occurred. For example, in an embodiment, the control system may determine that a location of the vehicle along the path matches a stored location in the memory. As such, the control system may instruct the vehicle to transition from the riding configuration to the walking configuration. In the walking configuration, for example, the control system may instruct the vehicle to stop traversing along the path and remain stationary while the guest engages with the omnidirectional treadmill. For example, the control system may instruct a seat of the vehicle to transition between a seated configuration to a standing configuration such that the guest may stand on the omnidirectional treadmill. In another example, the control system may instruct the omnidirectional treadmill to transition from a folded configuration to an unfolded configuration. Still, in another configuration, the control system may instruct a vehicle actuator (e.g., a robot arm) to adjust a position and/or orientation of the guest in a direction to decrease a distance between the guest and the omnidirectional treadmill. As such, the guest may engage with the omnidirectional treadmill in the walking configuration.

After a prompt (e.g., lapse of a period of time, receipt of input, a particular position or orientation has been achieved, sensor feedback), which may be considered another triggering event, at block 108, the control system may instruct the vehicle to transition from the walking configuration to the riding configuration. For example, the control system may instruct the seat of the vehicle to transition back into the seated configuration, the omnidirectional treadmill to transition back into the folded configuration, and/or the robot arm to increase the distance between the guest and the omnidirectional treadmill. In certain embodiments, the control system may instruct the vehicle to traverse the path.

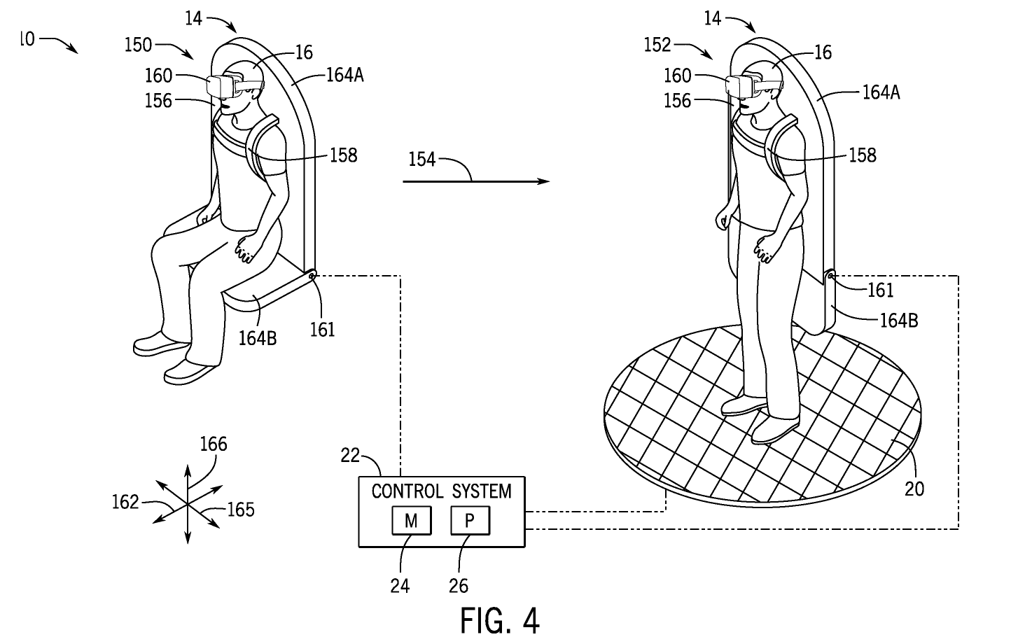

FIG. 4 is a schematic diagram of an embodiment the vehicle 14 of the attraction system 10 transitioning from the riding configuration 150 to the walking configuration 152, wherein the act of transitioning is illustrated by an arrow 154. For example, the vehicle 14 may traverse a portion of the path in the riding configuration 150 and transition to the walking configuration 152 while stationary. Additionally or alternatively, a seat 156 of the vehicle 14 may transition from the riding configuration 150 to the walking configuration 152 to facilitate interaction (e.g., rider engagement) between the one or more guests 16 and the one or more omnidirectional treadmills 20. It should be noted that the seat 156 may include any suitable number of seats within the vehicle 14.

As illustrated by FIG. 4, the seat 156 may couple to a harness 158 that may be worn by the one or more guests 16. The harness 158 may be physically tethered and/or coupled to the seat 156 (e.g., via one or more coupling mechanisms, such as a tether, a fastener, a connector, a locking device, and/or any other suitable coupling mechanism), thereby coupling the one or more guests 16 to the vehicle 14. The harness 158 may enable the one or more guests 16 to move within a threshold range relative to the seat 156. The seat 156 may also include a locking mechanism (e.g., lock, fastener) that couples to a portion of the harness 158 to ensure that the one or more guests 16 remain secure unless or until an authorized release is made.

The ride 12 may also include AR/VR glasses 160 (e.g., the show effect system 18) configured to display image data to the one or more guests 16. As discussed herein, the image data displayed to the one or more guests 16 may be updated based on a location of the vehicle 14 within the ride 12, a configuration of the vehicle 14, and/or an indication from the one or more omnidirectional treadmills 20. For example, the control system 22 may generate first image data when the vehicle 14 is in the riding configuration 150, generate second image data when the vehicle 14 transitions to the walking configuration 152, update the second image data based on the indication of movement from the one or more omnidirectional treadmills 20 in the walking configuration 152, and/or generate third image data when the vehicle 14 transitions back to the riding configuration 150. As such, the control system 22 may facilitate an immersive and/or interactive experience for the one or more guests 16.

In the riding configuration 150, the vehicle 14 may traverse a path (e.g., path 60) and the one or more guests 16 may be seated on the seat 156 and view images (e.g., visual effects) via the AR/VR glasses 160. For example, the vehicle 14 may traverse in a longitudinal direction parallel to a longitudinal direction 162 along the path. Additionally or alternatively, the show effect system 18 may include speakers and/or a display system proximate to the path and configured to output visual and/or audio effects as the vehicle 14 traverses the path. In an embodiment, the one or more guests 16 may be standing within the vehicle 14 in the riding configuration 150. For example, the one or more guests 16 may stand proximate to a side of the vehicle 14 and the harness 158 may be tethered to the side of the vehicle 14 in a lateral direction parallel to a lateral direction 165.

In the walking configuration 152, the one or more guests 16 may interact (e.g., engage) with the omnidirectional treadmills 20. In an embodiment, the one or more omnidirectional treadmills 20 may be positioned within the vehicle 14, such as on a floor of the vehicle 14 below the one or more guests 16, in a vertical direction parallel to a vertical direction 166 of the one or more guests 16. The control system 22 may instruct the seat 156 of the vehicle 14 to transition from a seated configuration, as illustrated in the riding configuration 150, to a standing configuration, as illustrated in the walking configuration 152. For example, the seat 156 may include a hinge 161 coupling together a first portion 164A of the seat 156 and a second portion 164B of the seat 156 such that the first portion 164A and the second portion 164B form, for example, a 45-degree angle, a 60-degree angle, a 90-degree angle, or any other suitable angle in the seated configuration. The hinge 161 is configured to rotate the first portion 164A relative to the second portion 164B such that the first portion 164A and the second portion 164B form a 180-degree angle in the walking configuration 152. As such, the seat 156 may transition to a standing position such that the one or more guests 16 may stand on and/or engage with the one or more omnidirectional treadmills 20 for rider engagement. For example, the one or more guests 16 may move in any direction on the one or more omnidirectional treadmills 20 while being tethered to the seat 156. While FIG. 4 depicts a particular embodiment, other embodiments are contemplated that utilize different angles (e.g., a 45-degree angle in the seated configuration and a 200-degree angle in the walking configuration) and/or different mechanisms. For example, in some embodiments, the second portion 164B may include a rider support that linearly retracts in a direction parallel to direction 162 to allow the legs of the one or more guests 16 to extend downward into engagement with the one or more omnidirectional treadmills 20.

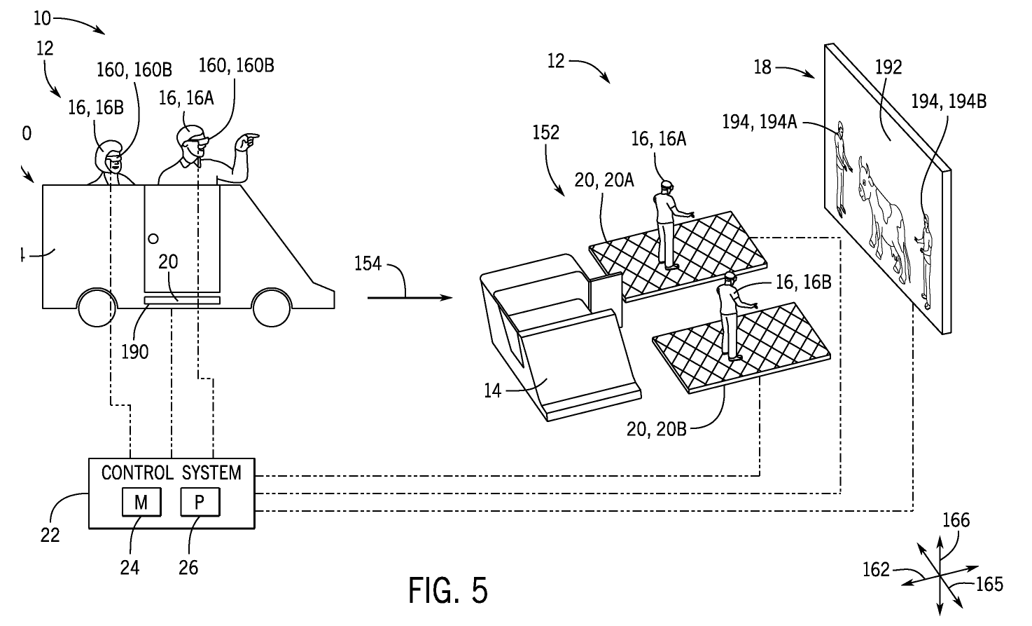

FIG. 5 is a schematic diagram of an embodiment of the attraction system 10 including the ride 12 and the vehicle 14 transitioning from the riding configuration 150 to the walking configuration 152, wherein the act of transitioning is illustrated by the arrow 154. In an embodiment, the one or more omnidirectional treadmills 20 may be coupled to an exterior surface (e.g., lateral side) of the vehicle 14. The vehicle 14 may include an actuator configured to rotate a position and/or orientation of the one or more omnidirectional treadmills 20 in a lateral direction parallel to the lateral direction 165. In an embodiment, the one or more omnidirectional treadmills 20 may be positioned within the vehicle 14 (e.g., nested within a storage area 190 of the vehicle 14). For example, the one or more omnidirectional treadmills 20 may be stored within a storage area 190 (e.g., receptacle, compartment) of the vehicle 14 and proximate to a floor of the vehicle 14. The storage area 190 may include a recess within, or a space proximate to a portion of, the vehicle 14, and an actuator is configured to cause the one or more omnidirectional treadmills 20 to retract within, fold under, fold proximate to, or otherwise transition to storage within or proximate to the vehicle 14 in the riding configuration 150 and extend from the vehicle 14 (e.g., in the lateral direction parallel to the lateral direction 165) in the walking configuration 152.

In the riding configuration 150, the vehicle 14 may traverse the path 60 and the omnidirectional treadmills 20 may be in a retracted configuration. As illustrated, the show effect system 18 may include the AR/VR glasses 160 worn by the one or more guests 16 during the ride to view visual effects while the vehicle 14 may be in motion. In the riding configuration 150, the omnidirectional treadmills 20 may be positioned against the exterior surface of the vehicle 14 or within the vehicle 14 in the retracted configuration.

In the walking configuration 152, the vehicle 14 may be stationary and the one or more omnidirectional treadmills 20 may be in an extended configuration. For example, the one or more omnidirectional treadmills 20 may extend in the lateral direction parallel to the lateral direction 165 from the exterior side or from the storage area of the vehicle 14. In the extended configuration, the one or more omnidirectional treadmills 20 may be proximate and/or adjacent to the floor. To interact with the one or more omnidirectional treadmills 20, the one or more guests 16 may exit the vehicle 14. As illustrated, each one or more guests 16 may interact with a respective one or more omnidirectional treadmills 20. For example, a first guest 16A of the one or more guests 16 may interact with a first omnidirectional treadmill 20A of the one or more omnidirectional treadmills 20 and a second guest 16B of the one or more guests 16 may interact with a second omnidirectional treadmill 20B of the one or more omnidirectional treadmills 20. In an embodiment, the one or more guests 16 may remove the AR/VR glasses 160 and view image data displayed by a display system 192 (e.g., the show effect system 18). For example, the control system 22 may receive an indication of movement from the omnidirectional treadmills 20 and update image data displayed by the show effect system 18 based on the indication.

In an embodiment, the one or more guests 16 may create one or more avatars 194 prior to entering the vehicle 14. The control system 22 may store an indication of the avatar 194 created by the one or more guests 16 and generate image data indicative of the avatar 194 for each of the one or more guests 16. For example, the control system 22 may generate and display a first avatar 194A of the one or more avatars 194 created by the first guest 16A and a second avatar 194B of the one or more avatars 194 created by the second guest 16B. The control system 22 may update a position and/or orientation of the first avatar 194A within the image data based on an indication of movement from the first omnidirectional treadmill 20A and update a position and/or orientation of the second avatar 194, 194B within the image data based on the indication of movement from the second omnidirectional treadmill 20B. In other instances, the control system 22 may update a perspective view of the image data viewed by the first guest 16A and/or the second guest 16B based on a respective indication of movement from the first guest 16A and/or the second guest 16B.

In an embodiment, the one or more guests 16 may view a respective display system. For example, the first guest 16A may view a first display system and the second guest 16B may view a second display system. The control system 22 may adjust the image data output by the respective display system based on an indication of movement from a respective omnidirectional treadmill 20 of the one or more omnidirectional treadmills 20. For example, the control system 22 may adjust first image data output by the first display system based on an indication of movement from the first omnidirectional treadmill 20A and adjust second image data output by the second display system based on an indication of movement from the second omnidirectional treadmill 20B. In another example, the control system 22 may rotate a point of view within the first image data based on a direction of movement within the indication from the first omnidirectional treadmill 20A. As such, the control system 22 may create an immersive and/or interactive environment for the one or more guests 16.

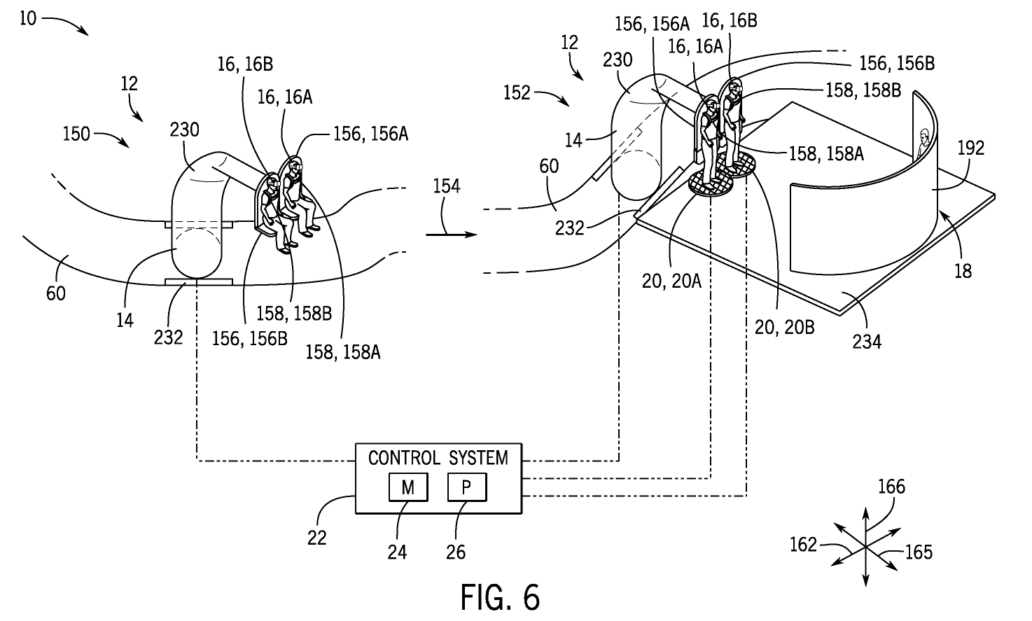

FIG. 6 is a schematic diagram of an embodiment of the attraction system 10 including the ride 12 with the vehicle 14 transitioning from the riding configuration 150 to the walking configuration 152, wherein the act of transitioning is illustrated by the arrow 154. In certain instances, the vehicle 14 may be a robot arm 230 that traverses the path 60. The robot arm 230 may include multiple joints, which may facilitate movement of the robot arm 230 in different directions, multiple links that connect to respective joints, an end effector, actuators, sensors, and so on. For example, the end effector of the robot arm 230 may couple to the one or more guests 16, such as via the seat 156 and/or the harness 158. As such, the robot arm 230 may adjust a position and/or orientation of the one or more guests 16 during the ride 12, such as between the riding configuration 150 and the walking configuration 152.

In the riding configuration 150, the robot arm 230 may couple to the guests 16 via the seat 156 and adjust a position and/or orientation of the one or more guests 16 along the path 60. For example, the robot arm 230 may couple to the seat 156 supporting the one or more guests 16. After the one or more guests 16 sit in and/or are coupled to the seat 156 via the harness 158, the control system 22 may instruct the robot arm 230 to traverse the path 60. For example, the robot arm 230 may traverse the path 60 using a bogie 232 that is integrated with the robot arm 230.

The control system 22 may determine a location of the robot arm 230 along the path 60. If the control system 22 determines that a location of the robot arm 230 matches a stored location in the memory 24 corresponding to a walking simulation portion of the ride, then the control system 22 may instruct the robot arm 230 to transition to the walking configuration 152. At the location corresponding to the stored location, the ride 12 may include a platform 234 with the one or more omnidirectional treadmills 20 and the show effect system 18. As such, the one or more guests 16 may interact with the one or more omnidirectional treadmills 20 and view image data outputted by the show effect system 18.

In the walking configuration 152, the robot arm 230 may be stationary with respect to traversing the path 60 and rotate in a lateral direction parallel to the lateral direction 165 to position the one or more guests 16 above the platform 234 with the one or more omnidirectional treadmills 20. The robot arm 230 may lower the one or more guests 16 in a vertical direction parallel to the vertical direction 166 onto the one or more omnidirectional treadmills 20 adjacent to the path 60. For example, the robot arm 230 may lower the first guest 16A onto the first omnidirectional treadmill 20A and the second guest 16B onto the second omnidirectional treadmill 20B to facilitate rider engagement. In this way, the robot arm 230 may facilitate rider engagement between the first guest 16A and the first omnidirectional treadmill 20A and the second guest 16B and the second omnidirectional treadmill 20B by adjusting a position and/or an orientation of the first seat 156A supporting the first guest 16A and a position and/or orientation of the second seat 156B supporting the second guest 16B. The ride 12 may also include the show effect system 18 positioned proximate to the first omnidirectional treadmill 20A and the second omnidirectional treadmill 20B to display respective image data to the first guest 16A and the second guest 16B. As discussed herein, the control system 22 may receive an indication of movement from the omnidirectional treadmills 20 and adjust the image data displayed by the show effect system 18 based on the indication. As such, the ride 12 may create and/or provide an immersive and interactive experience for the one or more guests 16.

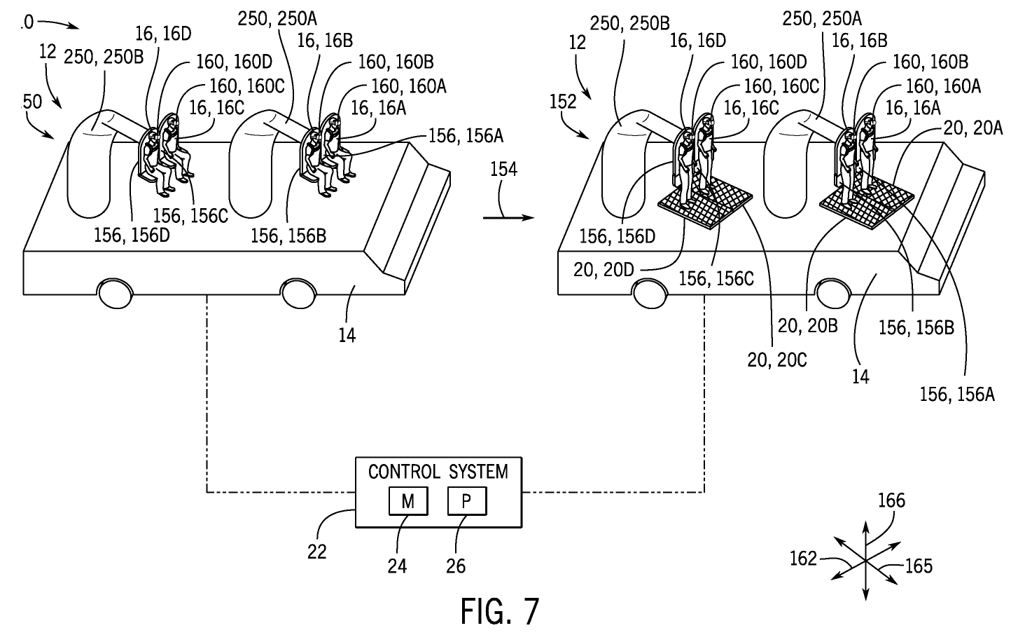

FIG. 7 is a schematic diagram of an embodiment of the attraction system 10 including the ride 12 with the vehicle 14 transitioning from the riding configuration 150 to the walking configuration 152, wherein the act of transitioning is illustrated by the arrow 154. As illustrated, the vehicle 14 may include a first robot arm 250A coupled to the first seat 156A supporting a first guest 16A and a second seat 156B supporting a second guest 16B and a second robot arm 250B coupled to a third seat 156C supporting a third guest 16C of the one or more guests 16 and a fourth seat 156D supporting a fourth guest 16D. Each of the one or more guests 16 may wear a pair of AR/VR glasses 160 to view visual effects provided by the control system 22 during the ride. The vehicle 14 may also include the one or more omnidirectional treadmills 20 (e.g., the first omnidirectional treadmill 20A, the second omnidirectional treadmill 20B, the third omnidirectional treadmill 20C, the fourth omnidirectional treadmill 20D) positioned on the floor of the vehicle 14 and/or below the seat 156 in a vertical direction parallel to the vertical direction 166. As illustrated, the vehicle 14 may provide respective omnidirectional treadmills 20 for each of the one or more guests 16 within the vehicle 14. The robot arm 250 may adjust a position and/or orientation of the one or more guests 16 within the vehicle 14 and/or with respect to the one or more omnidirectional treadmills 20 to facilitate interaction in the walking configuration 152. In the walking configuration 152, the control system 22 may receive an indication of movement from each of the one or more omnidirectional treadmills 20 and update image data projected by a respective pair of AR/VR glasses 160 (e.g., a first pair of AR/VR glasses 160A of the AR/VR glasses 160, a second pair of AR/VR glasses 160B of the AR/VR glasses 160, a third pair of AR/VR glasses 160C of the AR/VR glasses 160, a fourth pair of AR/VR glasses 160D of the AR/VR glasses 160) based on the indication of movement.

With the foregoing in mind, in the riding configuration 150, the robot arm 250 may position the one or more guests 16 above the one or more omnidirectional treadmills 20 in a vertical direction parallel to the vertical direction 166. The one or more guests 16 may be seated in respective seats 156 coupled to the robot arm 250. As the vehicle 14 traverses the path 60, the robot arm 250 may adjust a position and/or orientation of the one or more guests 16 to provide movement to complement the movement of the vehicle 14 along the path 60, which may provide a unique and/or entertaining experience for the one or more guests 16. For example, the robot arm 250 may adjust a position of the one or more guests 16 in a vertical direction parallel to the vertical direction 166, a lateral direction parallel to the lateral direction 165, a longitudinal direction parallel to the longitudinal direction 162, or combinations thereof. Additionally or alternatively, the robot arm 250 may adjust an orientation of the one or more guests 16 by rotating and/or adjust an angle of the respective seats 156.

In the walking configuration 152, the robot arm 250 may adjust the position and/or orientation of the one or more guests 16 (e.g., in a vertical direction parallel to direction 166) such that the one or more guests 16 may interact with the one or more omnidirectional treadmills 20 and/or to facilitate rider engagement. As discussed herein, the one or more omnidirectional treadmills 20 may be proximate to a floor of the vehicle 14 and/or below the seat 156 in the vertical direction parallel to the vertical direction 166. To facilitate the interaction, for example, the control system 22 may instruct the robot arm 250 to lower the one or more guests 16 to decrease a distance between the one or more guests 16 and the one or more omnidirectional treadmills 20. The control system 22 may adjust the image data output by the show effect system 18 based on the vehicle 14 being in the walking configuration 152, the robot arm 250 adjusting the position and/or orientation of the guests 16, and/or an indication of movement from the one or more omnidirectional treadmills 20 during guest interaction. For example, the one or more guests 16 may wear AR/VR glasses 160 during the ride 12 and the control system 22 may adjust the image data output by the AR/VR glasses 160 during the walking configuration 152, the riding configuration 150, or both, thereby creating and/or providing an immersive environment for the guests 16.

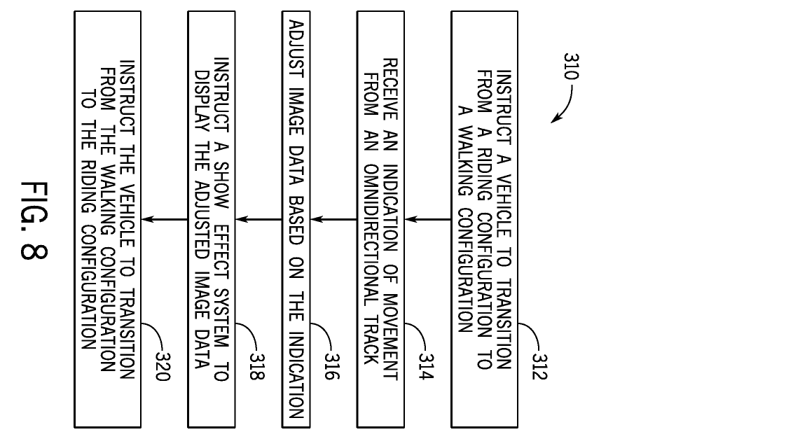

FIG. 8 is a flowchart of an example method 310 for adjusting the image data displayed by the walkable ride system of the attraction system. Any suitable device (e.g., the processing circuitry 26 of the control system 22 illustrated in FIGS. 1 and 2) may perform the method 310. In one embodiment, the method 310 may be implemented by executing instructions stored in a tangible, non-transitory, computer-readable medium (e.g., the memory 24 of the control system 22). For example, the method 310 may be performed at least in part by one or more software components, one or more software applications, and the like. While the method 310 is described using steps in a specific sequence, additional steps may be performed, the described steps may be performed in different sequences than the sequence illustrated, and/or certain described steps may be skipped or not performed altogether.

At block 312, the control system may instruct a vehicle to transition from a riding configuration to a walking configuration. For example, the control system may instruct the vehicle to stop traversing the path and remain stationary. In certain instances, the control system may also instruct the omnidirectional treadmill to transition from a folded configuration to an unfolded configuration. In another example, the control system may instruct the vehicle to move in a vertical direction to transition from the riding configuration to the walking configuration.

At block 314, the control system may receive an indication of movement from an omnidirectional treadmill. As the guest interacts with the omnidirectional treadmill, the omnidirectional treadmill may generate an indication of movement in a direction, a speed of the movement, or both. The omnidirectional treadmill may transmit the indication to the control system.

At block 316, the control system may adjust image data based on the indication of movement. The control system may update the image data based on the direction of movement, the speed of movement, or both. For example, the control system may generate image data indicative of a creature chasing an avatar of the guest. The control system may update a position and/or an orientation of the avatar based on the indication from the omnidirectional treadmill. For example, if the guest increases a speed of movement on the omnidirectional treadmill, then the control system may increase a speed of movement of the avatar. In another example, if the guest turns (e.g., changes a direction of movement), then the control system may adjust a position and/or orientation of the avatar. In other words, the control system may adjust the position and/or orientation of the avatar based on the position and/or orientation of the guest’s movement on the omnidirectional treadmill.

At block 318, the control system may instruct a show effect system to display the adjusted image data. The control system may transmit the updated image data to the show effect system for display to the guest. For example, the updated image data may include a motion similar to the motion of the guest on the omnidirectional treadmill.

At block 320, the control system may instruct the vehicle to transition from the walking configuration to the riding configuration. After a period of time, the control system may instruct the vehicle to continue traversing the path and/or disengage the guest from the omnidirectional treadmill. For example, the control system may instruct the robot arm to increase a distance between the guest and the omnidirectional treadmill by adjusting a position and/or direction of the guest in a vertical direction. In another example, the control system may instruct the omnidirectional treadmill to adjust a configuration, such as from the unfolded configuration to the folded configuration. The control system may instruct the show effect system to output an indication of the transition to the guest. For example, the indication may prompt the guest to return to the vehicle. In another example, the indication may prompt the guest to transition from standing to sitting. As such, the vehicle may transition back to the riding configuration.

While only certain features of the disclosure have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]…” or “step for [perform]ing [a function]…”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. An attraction system comprising:
an omnidirectional treadmill configured to output an indication of movement;
a vehicle configured to support a rider and move along a path in a riding configuration and facilitate rider engagement with the omnidirectional treadmill in a walking configuration; and
a controller communicatively coupled to the omnidirectional treadmill and the vehicle, wherein the controller is configured to instruct the vehicle to transition from the riding configuration to the walking configuration in response to a triggering event.

2. The attraction system of claim 1, wherein the omnidirectional treadmill is positioned within the vehicle, and wherein the vehicle is configured to move a seat of the vehicle to facilitate the rider engagement with the omnidirectional treadmill.

3. The attraction system of claim 1, wherein the omnidirectional treadmill is positioned within the vehicle, and wherein the vehicle is configured to operate a hinge of a seat of the vehicle to facilitate the rider engagement with the omnidirectional treadmill.

4. The attraction system of claim 1, wherein the omnidirectional treadmill is positioned proximate to the path, and wherein the vehicle is configured to extend a rider support from the vehicle to facilitate the rider engagement with the omnidirectional treadmill.

5. The attraction system of claim 4, comprising a show effect system proximate to the omnidirectional treadmill and configured to display image data.

6. The attraction system of claim 5, wherein the controller is communicatively coupled to the show effect system and configured to:
generate the image data for display by the show effect system; and
update the image data based on the indication of movement from the omnidirectional treadmill.

7. The attraction system of claim 1, comprising a show effect system configured to display image data, and wherein the controller is communicatively coupled to the show effect system, and the controller is configured to:
generate image data for display by the show effect system based on the vehicle being in the riding configuration; and
adjust the image data for display by the show effect system based on the vehicle being in the walking configuration.

8. The attraction system of claim 7, wherein the controller is configured to adjust the image data in the walking configuration based on the indication of movement from the omnidirectional treadmill.

9. The attraction system of claim 1, wherein the triggering event comprises determining a location of the vehicle corresponds to a stored location indicative of a walking simulation of the attraction system.

10. An attraction system comprising:
an omnidirectional treadmill configured to output an indication of movement; and
a vehicle configured to transition between a riding configuration and a walking configuration, wherein the vehicle is configured to traverse a path in the riding configuration, and wherein the vehicle is configured to remain stationary relative to the path to facilitate rider engagement with the omnidirectional treadmill in the walking configuration.

11. The attraction system of claim 10, wherein the vehicle comprises a robot arm configured to adjust a position and/or orientation of a seat to facilitate the rider engagement with the omnidirectional treadmill in the walking configuration.

12. The attraction system of claim 11, wherein the omnidirectional treadmill is positioned within the vehicle, and wherein the robot arm is configured to adjust a position and/or orientation of the seat in a vertical direction to facilitate the rider engagement with the omnidirectional treadmill.

13. The attraction system of claim 11, wherein the omnidirectional treadmill is positioned proximate to the path, and wherein the robot arm is configured to adjust a position and/or orientation of the seat in a lateral direction to facilitate engagement with the omnidirectional treadmill.

14. The attraction system of claim 10, wherein the omnidirectional treadmill is configured to be folded adjacent or proximate the vehicle in the riding configuration and fold out from the vehicle in the walking configuration.

15. The attraction system of claim 10, comprising a display system positioned proximate the omnidirectional treadmill and configured to display image data.

16. The attraction system of claim 15, comprising a control system communicatively coupled to the omnidirectional treadmill, the vehicle, and the display system, wherein the control system is configured to:
generate the image data based on a configuration of the vehicle;
update the image data based on receiving the indication of movement from the omnidirectional treadmill; and
instruct the display system to display the updated image data.

17. An attraction system comprising:
a show effect system configured to display image data;
an omnidirectional treadmill configured to output an indication of movement of a treadmill component;
a vehicle configured to support a rider and move along a path in a riding configuration and facilitate rider engagement with the omnidirectional treadmill in a walking configuration; and
a controller communicatively coupled to the omnidirectional treadmill and the vehicle, wherein the controller is configured to:
instruct the vehicle to transition from the riding configuration to the walking configuration in response to a triggering event; and
generate image data for the show effect system based on the indication of movement from the omnidirectional treadmill.

18. The attraction system of claim 17, wherein the vehicle comprises a robot arm configured to adjust a position and/or an orientation of a seat of the vehicle to facilitate the rider engagement with the omnidirectional treadmill.

19. The attraction system of claim 17, wherein the vehicle comprises a robot arm configured to adjust a position and/or an orientation of the vehicle in a vertical and/or lateral direction to facilitate the rider engagement with the omnidirectional treadmill.

20. The attraction system of claim 17, wherein the controller is configured to:
determine a location of the vehicle along the path; and
determine the triggering event based on the location of the vehicle corresponding to a stored location indicative of a walking simulation of the attraction system.
